(19) United States
(12) Patent Application Publication
(10) Pub. No.: US 2008/0098820 A1
(43) Pub. Date: May 1, 2008

(54) Force Measuring Device, Especially Pressure Gauge, And Associated Production Method

(76) Inventors: Joachim Morsch, Alsweiler (DE); Jens Rabe, Bexbach (DE); Wolfgang Brode, Hermsdorf (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/661,494

(22) PCT Filed: Dec. 21, 2005
(86) PCT No.: PCT/EP05/13749

§ 371 Date: Feb. 27, 2007

(30) Foreign Application Priority Data
Jan. 3, 2005 (DE) 102005001298.1

(51) Int. Cl. G01L 9/00

(52) U.S. Cl. 73/717

(57) ABSTRACT

The invention relates to a force measuring device, especially a pressure gauge (1), comprising a deformation element (2) that can be deformed as a result of an impingement by a force, particularly pressure, and at least one measuring element (4a, 4b) by means of which a deformation of the deformation element (2) can be converted into an electrical test signal. The measuring element (4a, 4b) is disposed on a planar substrate (6) which is attached to the deformation element (2) such that a deformation of the deformation element (2) caused by the impingement by a force also results in the substrate (6) being deformed. The inventive force measuring device is characterized in that the substrate (6) is made of an electrically insulating material while the substrate (6) is provided with less flexural rigidity than the deformation element (2) as a result of the material of which the same is made. Also disclosed is an associated production method.

The invention relates to a force measuring device, especially a pressure gauge, and the associated production method.

In known pressure sensors, a deformation element is used which consists for example of high-grade steel or other essentially elastically deformable material. Strain-sensitive resistors are applied to the deformation element in thick film or thin film technology, and in particular in the region of the deformation element which deforms in a predetermined manner when pressure is applied. The deformation element is a pressure membrane which separates the high pressure side from the low pressure side and deforms according to the prevailing pressure difference.

In the known devices it is necessary for the entire deformation element to be subjected to the working steps of thick film technology or thin film technology for producing the measurement elements. This requires great effort in the production of these devices. In a further development of the known devices the measurement elements are applied to the high-grade steel substrate to which an electrically insulating cover layer must be applied before application of the measurement elements. Then the high-grade steel substrate is fixed by spot welding on the deformation element which likewise consists of high-grade steel. This also dictates a high level of material use and a complex production process.

Therefore the object of the invention is to make available a device and the associated production process which overcome the disadvantages of the prior art. In particular, the devices claimed for the invention are to be economical to produce, easily adaptable to different force measurement ranges, and durable and reliable in operation. Preferably these devices are to have high long-term stability, good linearity and low temperature dependency of the measurement signals. The associated production process is to be economical to implement.

This object is achieved by the device defined in claim 1 and by the process defined in the independent claim. Special embodiments of the invention are defined in the dependent claims.

In a force measuring device, especially in a pressure sensor, with a deformation element which can be deformed as the result of the application of a force, especially as a result of application of pressure, and with at least one measurement element, by means of which the deformation of the deformation element can be converted into an electrical measurement signal, the measurement element being located on a flat substrate, and the substrate being fixed on the deformation element such that deformation of the deformation element as a result of application of a force also results in deformation of the substrate, the object being achieved in that the substrate consists of an electrically insulating material and in that the substrate has lower bending stiffness than the deformation element due to its material and/or shape.

Fundamentally, with the device as claimed in the invention a plurality of physical quantities can be measured and converted into a force. In particular, the device as claimed in the invention can be made as a pressure sensor, both as an absolute pressure sensor and also as a differential pressure sensor. The use of the invention for high pressure sensors with a rated pressure range of 100 bar or more, especially up to for example 600 bar, is especially advantageous. Moreover the device as claimed in the invention can be used for example as an acceleration sensor, in this case the deformation element being made as a spring element which is clamped on at least one side and which as a result of acceleration deforms by the inertia of its own mass or a mass body located on the spring element.

Besides the known strain gauges, alternatively or in addition piezoresistive measurement elements with a high K-factor of for example from 2 to 50, especially piezoresistive resistors of a polycrystalline material, for example doped polysilicon; can also be used as the measurement elements. Furthermore, piezoelectric measurement elements can also be used or electrode surfaces can be applied which enable capacitive evaluation of deformation.

The measurement elements are applied preferably in thin film technology or thick film technology. Application can take place over the entire surface or in any event unstructured, for example by cathode sputtering or vapor deposition, with subsequent structuring, for example by photolithographic processes and wet-chemical or dry-chemical etching. Alternatively, the measurement elements can also be applied structured, for example by screen printing, stamping, masked cathode sputtering or the like.

Preferably four-measurement elements in the form of four multiplier resistors are interconnected to form a full bridge. The measurement elements are preferably applied to the flat substrate in a panel, and a plurality of substrates in the panel can be produced on a so-called wafer. The thickness of the substrate is typically between 50 μm and 500 μm, especially between 80 and 300 μm. The thickness of the deformation element is in any case typically in the range from 150 μm to 600 μm in the region of the measurement element so that no significant stiffening of the deformation element takes place by fixing the substrate. The deformation element itself consists preferably of high-grade steel, an alloy which is inert to the medium to be measured, ceramic or the like.

The substrate consists of an electrically insulating material, preferably of a so-called low temperature cofired ceramic (LTCC), a glass ceramic, a ceramic-glass composite or also of a pure glass. These materials compared to the materials of conventional deformation bodies advantageously have a low modulus of elasticity and high fracture strength. The surface of the substrate can be polished, especially when the measurement elements are applied in thin film technology. When the measurement elements are applied in thick film technology, unpolished surfaces of the substrate can also be coated; this is advantageous.

In one special embodiment the substrate is built up from several layers, the individual layers being present as a foil before sintering, and being tightly joined to one another by sintering. The first, preferably inner layer can primarily determine the mechanical stability of the substrate, conversely a second, preferably outer layer primarily forms a surface with low roughness, so that thin film components such as printed conductors, resistors or the like can be applied to this surface. The layers are foil-like and flexible in the unsintered state.

The first, inner layer consists preferably of a glass ceramic with a high proportion of a comparatively coarse-grained filler, for example zirconium dioxide. The portion of the filler is more than 50% by weight, especially between 50 and 80% by weight. The grain size D50 is more than 1 μm, especially more than 3 μm. The second, outer layer is conversely produced with a finely-ground powder with a grain size D50 of less than 1 μm from ceramic and noncrystallizing glasses. This yields an outer layer with almost pore-free, fine-grained structure with very low surface roughness in sintering.

Layered structures with at least one first inner layer, and on the outside with at least one second layer, preferably on both outer sides of the substrate with at least one second layer, are especially favorable. In particular, especially those layered structures with several first, inner layers, for example a layered structure with a stacking ratio of the outer to the inner layers from 2:2 to 2:6, i.e., two second, outer layers, and two to six first inner layers, are favorable.

In one special embodiment the coefficient of thermal expansion of the substrate is matched to the coefficient of thermal expansion of the deformation element. Thus the difference of the coefficients of thermal expansion of the substrate and deformation element in the temperature range of interest is generally less than 5 ppm/K, preferably less than 3 ppm/K, and in a limited temperature range down to less than 1 ppm/K. This avoids deformations which are caused by temperature fluctuations and which lead to an output signal of the measurement element and thus of the pressure sensor, although a corresponding pressure change cannot be detected.

In any event the interconnect between the substrate and deformation element takes place preferably superficially in sections. Depending on the materials for the deformation element and the substrate, fundamentally also interconnects are possible which do not require a separate interconnecting layer, such as for example eutectic bonding with the formation of eutectics, or so-called anode bonding with suitable technical glasses. Especially when using ceramics which have not been specially surface-treated, the use of a separate interconnecting layer is however advantageous. For example an adhesive layer, for example an epoxy adhesive or a polyimide adhesive, a metal solder or a glass solder, can be used as the interconnecting layer. The interconnecting layers can be applied on one side or two sides to the substrate or the deformation element. The application of the interconnecting layer can take place already structured, for example by screen printing or by stamping on an adhesive paste or a glass solder paste. The interconnecting layer can also be applied over the entire surface and then structured. Fundamentally all processes known from thick film technology and thin film technology can be used for this purpose, including photolithographic structuring and use of wet etching techniques and dry etching techniques for structuring.

In one special embodiment the configuration of the deformation element and substrate has a cavity, preferably in the region of the measurement element. This cavity can be formed by the structure of the interconnecting layer, by structuring of the substrate and/or by structuring of the deformation element. The mechanical stresses and strains can be concentrated or intensified by the cavity in the regions of the substrate in which the measurement elements are located. This yields increased linearity of the output signal of the device and in this way at a given allowable nonlinearity the measurement sensitivity of the device can be increased. Furthermore, it is advantageous if at least between some of the measurement elements which are present on the substrate and which are configured in the region of the cavity there is an interconnecting site between the substrate and interconnecting element.

In one special embodiment the substrate is fixed with mechanical prestressing on the deformation element so that in the unloaded state of the device a significant output signal results. With subsequent application of a force, prestressing is at least partially compensated or the output signal becomes smaller. This is advantageous because in the event of overloading of the device the overload safety is increased.

This prestressing can also be induced for example by temporarily placing spacers in the regions of the cavities between the substrate and the connecting element, for example in the form of polymer layers which can be removed after the substrate is fixed, for example by the corresponding wet chemical or dry-chemical processes.

The invention also relates to a process for manufacturing a force measuring device, the deformation element and the substrate with the measurement elements being produced separately from one another. The substrate with the measurement elements belonging to the device is detached after production process which preferably takes place in a panel, and is then fixed on the deformation element, as already described above. The interconnect between the substrate and the deformation element can also take place over the entire surface so that the substrate with the measurement elements forms a type of coating of the deformation element.

The substrate is placed on the deformation element generally on the side of the deformation element facing away from the medium to be measured. In many applications, it will be possible to fix the substrate on the deformation element such that the side with the measurement elements points away from the deformation element. In this way, especially electrical contact-making of the measurement elements is simplified. But there are also applications in which it is especially advantageous if the substrate with its surface which has the measurement elements is facing the deformation element in order for example to prevent mechanical damage or contamination of the measurement elements.

Other advantages, features and details of the invention will become apparent from the dependent claims and the following description in which several embodiments are detailed with reference to the drawings. In this connection, the features mentioned in the claims and the description can be essential for the invention individually or in any combination.

FIG. 1 shows a cross section through a first embodiment of the invention,

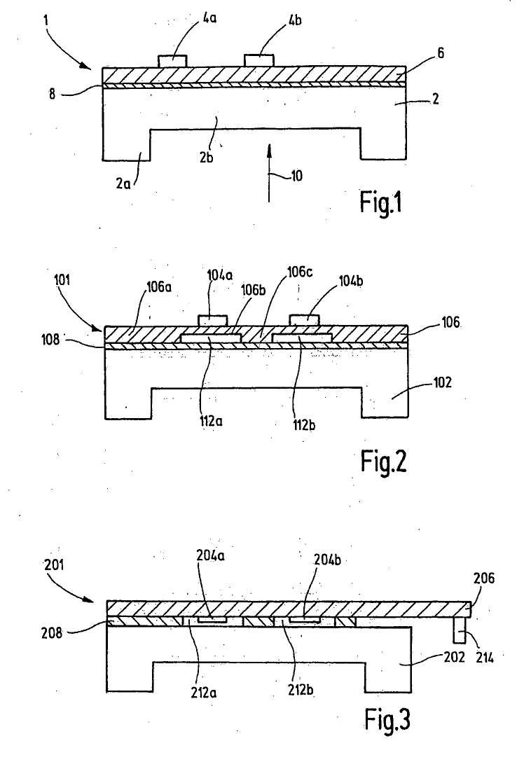

FIG. 2 shows a cross section through a second embodiment of the invention,

FIG. 3 shows a cross section through a third embodiment of the invention,

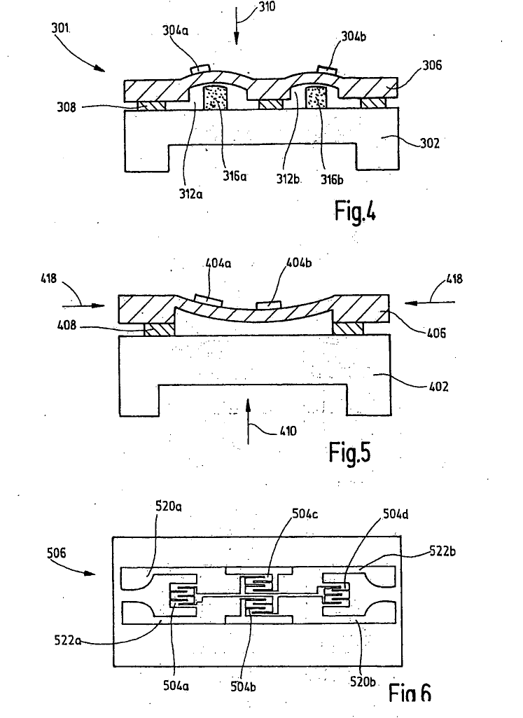

FIG. 4 shows a cross section through fourth embodiment of the invention,

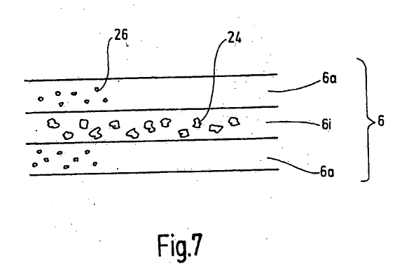

FIG. 5 shows a cross section through a fifth embodiment of the invention,

FIG. 6 shows an overhead view of the substrate as claimed in the invention, and

FIG. 7 shows a multilayer structure of a substrate as claimed in the invention.

FIG. 1 shows a cross section through a first embodiment of the invention. It is a pressure sensor 1 as claimed in the invention with a deformation element 2 and a substrate 6 which is fixed on it and on which there are two measurement elements 4a, 4b. The deformation element 2 is made from high-grade steel, especially from a cylindrical body which has a blind hole on the side facing the medium to be measured. This yields a peripheral edge area 2a of the deformation element 2 which has greater stiffness against sagging compared to the membrane region 2b which is located in between. The thickness of the deformation element 2 for example in the membrane region 2b is between 150 μm and 600 μm, conversely the thickness in the edge area 2a can increase and can be more than 1000 μm, in particular can also be between two and ten mm.

On the planar end face the substrate 6 is fixed on the deformation element 2, in this embodiment by means of a metal solder layer as the interconnecting layer 8 which is applied to the back of the substrate 6 which is essentially rectangular in an elevational view (see FIG. 6), for example by sputtering, vapor deposition or the like. If necessary or feasible, a corresponding metal solder layer can also be applied to the deformation element 2. The thickness of the metal solder layer 8 is distinctly less than the thickness of the membrane region 2b and is for example 50 μm. The substrate 6 is approximately 250 μm thick and consists of a so-called low temperature cofired ceramic LTCC) or of a glass ceramic or a glass with comparable properties. As a whole the bending stiffness of the membrane region 2b is not significantly increased by the metal solder layer 8 and the substrate 6. The deformation of the membrane region 2b which occurs as a result of application of pressure is transferred to the substrate 6 by the tight interconnection.

On the surface facing away from the deformation element 2 the measurement elements 4a, 4b are applied to the substrate 6 by vapor deposition and subsequent structuring. There are two resistors which are made as strain gauges. In the event of application of pressure in the direction of the arrow 10, the membrane region 2b and thus in the associated region the substrate 6 also arch up and the first measurement element 4a located near the edge experiences essentially compressive stresses, conversely the second measurement element 4b located near the center experiences essentially tensile stresses. If the two measurement elements 4a, 4b are interconnected to form a half bridge, at the connecting site an electrical potential can be tapped which is dependent on the applied pressure.

The coefficient of expansion of the substrate 6 is matched to the coefficient of expansion of the deformation element 2. Matching can be ensured especially by choosing the exact material composition for the substrate 6. In the case of a LTCC ceramic this can take place for example by the choice of the ceramic material and/or the glass components. In particular, by adding glass components with a comparatively small glass transition temperature, the coefficient of thermal expansion which is fundamentally low in ceramic materials can be increased and matched to the relatively large coefficient of thermal expansion of the metallic deformation element 2. Instead of high-grade steel, titanium, a ceramic or the like can also be used as the material for the deformation element 2, then the material of the substrate 6 being selected such that small differences in the coefficient of thermal expansion arise. To the extent the coefficient of thermal expansion of the materials themselves used is dependent on the temperature, matching in any event is effected for the temperature range in which the pressure sensor 1 is to be used.

In this context it is also critical that the temperature in the production of the interconnect between the substrate 6 and the deformation element 2 is as low as possible. Here it can be advantageous if the interconnecting layer 8 is formed by an adhesive which sets at comparatively low temperatures, for example by an epoxy adhesive or a polyimide adhesive. It is advantageous if the material of the substrate 6 and/or of the interconnecting layer 8 has a modulus of elasticity which is low especially compared to the material of the deformation element 2.

FIG. 2 shows a cross section through a second embodiment of the invention. The pressure sensor 101 in turn has a deformation element 102 of high-grade steel. On the for example circular end face which faces the substrate 106 the interconnecting layer l08 is applied to the deformation element 102 over the entire surface, for example by spin-on of an adhesive or a glass solder, or by immersion coating with a metallic brazing solder or soft solder. The substrate 106 is structured on the surface facing the deformation element 102 such that first regions 106a with a comparatively large layer thickness and second regions 106b with reduced layer thickness result. In the second regions 106b are the measurement elements 104a, 104b, the deformations routed from the deformation element 102 into the substrate 106 being concentrated in the second regions 106b. Moreover, in this way further decoupling of deformations is ensured which are induced only by temperature changes and based on a difference of coefficients of thermal expansion.

Between the two regions 106b and the deformation element 102, cavities 112 are formed which however are open on at least one side, in particular are open toward the space surrounding the substrate 106 on its side facing away from the deformation element 102. In the area between the two cavities 112a, 112b there is an interconnecting point 106c at which the substrate 106 is additionally connected to the deformation element 102. In one modifications of the second embodiment, alternatively or additionally to the structuring of the substrate 166 which forms the cavities 112a, 112b, the deformation element 102 can also be structured at the corresponding sites, in particular can have depressions at the corresponding sites.

FIG. 3 shows a cross section through a third embodiment of the invention. In turn the pressure sensor 201 has a deformation element 202 which consists for example of an aluminum oxide ceramic. On the end face of the deformation element 202 facing the substrate 206 at the outset a glass solder layer is applied over the entire surface as the interconnecting layer 208, for example by a spin-on process. Then the glass solder layer was structured, for example using photolithographic techniques, with subsequent etching of the glass solder. The substrate 206 is placed on the deformation element 202 which has been prepared in this way, the configuration is heated above the glass transition temperature of the glass solder, and then cooled again, so that a mechanically strong and if necessary also gas-tight interconnect between the deformation element 202 and the substrate 206 results.

Cavities 212a, 212b form according to the structure of the interconnecting layer 208. In the associated region on the substrate 206 the measurement elements 204a, 204b are located on the surface facing the deformation element 202. Electrical contact-making of the measurement elements 204a, 204b can take place in the edge area of the substrate 106 which projects beyond the deformation element 202, for example by means of a connecting element 214 located on the substrate 206. In this configuration the measurement elements 204a, 204b are effective against mechanical damage and/or against dirt and deposits of moisture. The connection between the measurement elements 204a, 204b takes place by printed conductors which are likewise applied to the substrate 206 in thick film technology or thin film technology. In hybrid technology moreover signal processing can also take place by means of an integrated circuit which can be located on the substrate 206.

FIG. 4 shows a cross section through a fourth embodiment of the invention. The substrate 306 is in turn structured on the surface facing the deformation element 302 so that in the fixed state cavities 312a, 312b are formed. The interconnecting layer 308 is provided only in spots in this embodiment. When the substrate 306 is fixed on the deformation element 302, in the region of the cavities 312a, 312b spacers 316a, 316b are inserted so that in the initial state in the region of the measurement elements 304a, 304b the illustrated arching of the substrate 306 occurs, even if the spacers 316a, 316b are removed after interconnecting the substrate 306 and deformation element 302. In this regard it is especially advantageous to use spacers 316a, 316b of a soluble polymer which can moreover also be applied in thick film or thin film technology to the deformation element 302 and/or the substrate 306. After interconnecting the substrate 306 and the deformation element 302 these spacers 316a, 316b can be washed out for example with solvents or incinerated in an oxidizing atmosphere.

Thus, without external application of pressure the regions of the substrate 306 in which the measurement elements 304a, 304b are located are arched beforehand and the measurement elements deliver a corresponding output signal. In the event of application of pressure in the direction of the arrow 310, this arching is compensated until for example the substrate 306 is also flat in the region of the measurement elements 304a, 304b when the nominal pressure is present. Thus it can be ensured that in the working region of the pressure sensor 301 only the range from compressive stress to stress-free is traversed, in the overload region thus there are strain reserves.

FIG. 5 shows a cross section through a fifth embodiment of the invention. In turn the substrate 406 is connected to the deformation element 402 by spot configuration of the interconnecting layer 408. In the connecting process in the direction of the arrows 418, a force can be applied to the substrate 406 so that arching of that region in which the measurement elements 404a, 404b are located arises in the direction to the deformation element 402 and is also frozen after hardening of the interconnecting layer 408. In this case prestressing arises which is compensated when pressure is applied in the direction of the arrow 410. In turn, this yields a strain reserve in the overload region.

FIG. 6 shows an overhead view of the substrate 506 as can be used for all the aforementioned embodiments. The total of four measurement elements 504a, 504b, 504c, 504d are interconnected to form a full bridge, the common electrode of the first measurement element 504a and of the third measurement element 504c being routed to the terminal electrode 520a located in the first corner of the substrate 506 for positive voltage supply. Analogously the common electrode of the second measurement element 504b and of the fourth measurement element 504d is routed to the terminal electrode 520b located in the second corner of the substrate 506 for negative voltage supply. The measurement voltage can be tapped between the common electrode of the first measurement element 504a and the second measurement element 504b, which is routed to the terminal electrode 522a located in the third corner of the substrate 506, and the common electrode of the third measurement element 504c and the fourth measurement element 504d which is routed to the terminal electrode 522b located in the fourth corner of the substrate 506.

The substrate 506 is essentially rectangular and can advantageously be produced on a circular or rectangular wafer in a large number, or in other words “in the panel”. Typical dimensions for the length and width are fractions of a mm to a few mm, the thickness of the substrate typically being less than one mm.

FIG. 7 shows the multilayer structure of a substrate 6 as claimed in the invention. In the illustrated embodiment a first, inner layer 6i is covered on both sides by a second outer layer 6a. The first, inner layer is formed from a glass ceramic with a proportion by weight between 50 and 80% of coarse filler particles 24 of zirconium oxide with a grain size D50 of more than 3 μm. The two second outer layers 6a are made essentially identical and have fine filler particles 26 of ceramic and noncrystallizing glasses with a grain size less than 1 μm. The thickness of the inner and outer layers 6i, 6a is approximately 100 μm each. The mechanical properties of the substrate 6 are essentially determined by the first inner layer 6i, by the coarse filler particles 24, and ensure high fracture strength of the substrate 6. The second outer layers 6a conversely ensure mainly a smooth surface of the substrate 6 to which the components such as printed conductors, resistors or the like can be applied in thin film technology.

The stacking ratio of the outer to the inner layers 6a, 6i in the illustrated embodiment is 2:1. Stacking ratios between 2:2 and 2:6 are especially advantageous, in this case up to six first, inner layers 6i being located on top of one another and the substrate 6 having one second, outer layer 6a only on the outer side.

1. A force measuring device, especially a pressure gauge (1), having a deformation element (2) which can be deformed as the result of the application of a force, especially as a result of application of pressure, and with at least one measurement element (4a, 4b), by means of which the deformation of the deformation element (2) can be converted into an electrical measurement signal, the measurement element (4a, 4b) being located on a flat substrate (6), and the substrate (6) being fixed on the deformation element (2) such that deformation of the deformation element (2) as a result of application of a force also results in deformation of the substrate (6), characterized in that the substrate (6) consists of an electrically insulating material and in that due to its material and/or shape the substrate (6) has lower bending stiffness than the deformation element (2).

2. The device as claimed in claim 1, wherein the thickness of the flat substrate (6) at least in the area of the measurement element (4a, 4b) is less than the thickness of the deformation element (2) in this region.

3. The device as claimed in claim 1, wherein the substrate (6) consists of a ceramic or glass-like material, especially of a glass ceramic or of a low-temperature cofired ceramic (LTCC).

4. The device as claimed in claim 1, wherein the substrate (6) has a multilayer structure with at least one first, inner layer (6) and at least one second, outer layer (6a).

5. The device as claimed in claim 4, wherein the first, inner layer (6i) has a composition different from the second, outer layer (6a), especially wherein the first, inner layer (6i) has a coarser filler than the second, outer layer (6a).

6. The device as claimed in claim 4, wherein at least two first, inner layers (6i) on the two outer sides of the substrate (6) are covered by at least one respective outer layer (6a).

7. The device as claimed in claim 1, wherein the substrate (6) has a coefficient of thermal expansion which is matched to the coefficient of thermal expansion of the deformation element (2), in particular wherein the difference of the coefficients of thermal expansion in the range between 0 and +100° C., preferably in the range between −40 and +125° C., is less than 5 ppm/K, preferably less than 3 ppm/K.

8. The device as claimed in claim 1, wherein the substrate (6) is fixed by means of an interconnecting layer (8) which is flat at least in regions, on the deformation element, in particular by means of an adhesive layer, a metal solder layer or a glass solder layer.

9. The device as claimed in claim 1, wherein the configuration consisting of the deformation element (2) and the substrate (6) in the region of the measurement element (4a, 4b) has a cavity between the substrate (6) and the connecting element (2).

10. The device as claimed in claim 6, wherein the device has at least two measurement elements (4a, 4b) which are each located in the region of a cavity and wherein between the two measurement elements (4a, 4b) there is an interconnecting site between the substrate (6) and the connecting element (2).

11. The device as claimed in claim 1, wherein the substrate (6) is fixed with mechanical prestressing on the deformation element (2) which can be at least partially compensated when a force is applied.

12. The device as claimed in claim 1, wherein the measurement element (4a, 4b) in the panel is applied to the substrate (6) in thin film technology or thick film technology.

13. A process for producing a force measuring device, especially for producing a pressure sensor (1), having a deformation element (2) which can be deformed as the result of the application of a force, especially as a result of application of pressure, and at least one measurement element (4a, 4b) being applied to the flat substrate (6) in the panel in thin film technology or thick film technology, and the substrate (6) consisting of an electrically insulating material and due to its material and/or shape having a lower bending stiffness than the deformation element (2) which has been produced separately from the substrate (6), and the substrate (6) being detached from the panel and then being fixed on the deformation element (2).

14. The process as claimed in claim 10, wherein the substrate (6) is fixed flat at least in areas on the deformation element (2).

15. The process as claimed in claim 11, wherein an interconnecting layer (8) is applied to the substrate (6) and/or the deformation element (2).

16. The process as claimed in claim 12, wherein the interconnecting layer (8) is applied over the entire surface and then structured.
